(19) United States
(12) Patent Application Publication
(10) Pub. No.: US 2014/0136428 A1
(43) Pub. Date: May 15, 2014

(54) VALIDATING A COMPANY USING INFORMATION FROM A SOCIAL NETWORK

(71) Applicants: Eric Kowalchyk, Mountain View, CA (US); Mui Anne Chang, Mountain View, CA (US); Vikram Rangnekar, Mountain View, CA (US)

(72) Inventors: Eric Kowalchyk, Mountain View, CA (US); Mui Anne Chang, Mountain View, CA (US); Vikram Rangnekar, Mountain View, CA (US)

(21) Appl. No.: 13/677,034

(22) Filed: Nov. 14, 2012

(51) Int. Cl. G06Q 30/00

(52) U.S. Cl. CPC G06Q 30/018
USPC 705/317

(57) ABSTRACT

Systems and methods for validating a company based on information provided by a social network are described. In some examples, a social network receives a request to validate a company, identifies information associated with the company, and validates the company based on the identified information.

### TECHNICAL FIELD

The present disclosure generally relates to verification and/or validation services. More specifically, the present disclosure relates to methods, systems and computer program products for validating a company using information from a social network.

### BACKGROUND

Before hiring a company or person provide a service, a person will often vet, or attempt to vet, the company—he/she may read reviews about the company, look an examples of previous work or experiences, and so on. However, for many companies and independent contractors, there may be little anecdotal evidence available that provides the person with insight into their qualities. In such cases, a person may choose not to hire a qualified company or contractor because of this lack of information, as the person may not wish to engage with an unknown entity.

### DESCRIPTION OF THE DRAWINGS

Some embodiments of the technology are illustrated by way of example and not limitation in the figures of the accompanying drawings, in which:

FIG. 1 is a block diagram illustrating an example of a network environment including a server operating a system for validating a company using information from a social network, consistent with some embodiments.

FIG. 2 is a block diagram illustrating modules of a validation system, consistent with some embodiments.

FIG. 3 is a flow diagram illustrating an example method for validating a company using information from a social network, consistent with some embodiments.

FIG. 4 is a flow diagram illustrating an example method for determining a validation score to a company, consistent with some embodiments.

FIG. 5 is a block diagram of a machine in the form of a computing device within which a set of instructions, for causing the machine to perform any one or more of the methodologies discussed herein, may be executed.

### DETAILED DESCRIPTION

### Overview

The present disclosure describes methods, systems, and computer program products, which individually provide functionality for validating a company using information from a social network. In some examples, the systems and methods enable a person to request and obtain information about a company, such as information that may be used to validate the company, from a social network, such as an online professional network.

In some examples, a social network may include, or engage, a validation system that is configured to receive a request to provide information associated with a company, obtain information associated with the company from a social network, and provide the obtained information.

As an example, a parent wishes to hire a math tutor for her daughter. The parent connects with a validation system associated with an online professional network, and sends a request for information about a potential tutor named Cal Culas. The validation system identifies and obtains information about the potential tutor, including information identifying previous teaching jobs and a degree in Mathematics, as well as a number of connections within the social network to other tutors and members working in the Math and Science fields. The validation system, based on the identified information, validates Cal Culas as being a tutor of a sufficient quality and returns an indication of the quality to the parent.

Thus, in some examples, a validation system may leverage information stored by a social network, such as an online professional network, when providing information associated with a company or individual providing professional services that may assist in validating or otherwise sanctioning the company or individual, among other things. The validation system may, therefore, provide insight about the company to a requestor, such as a person wishing to hire the company, enabling the person to properly vet and/or obtain additional information about the company, among other things.

In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Other advantages and aspects of the inventive subject matter will be readily apparent from the description of the figures that follows.

### Suitable System

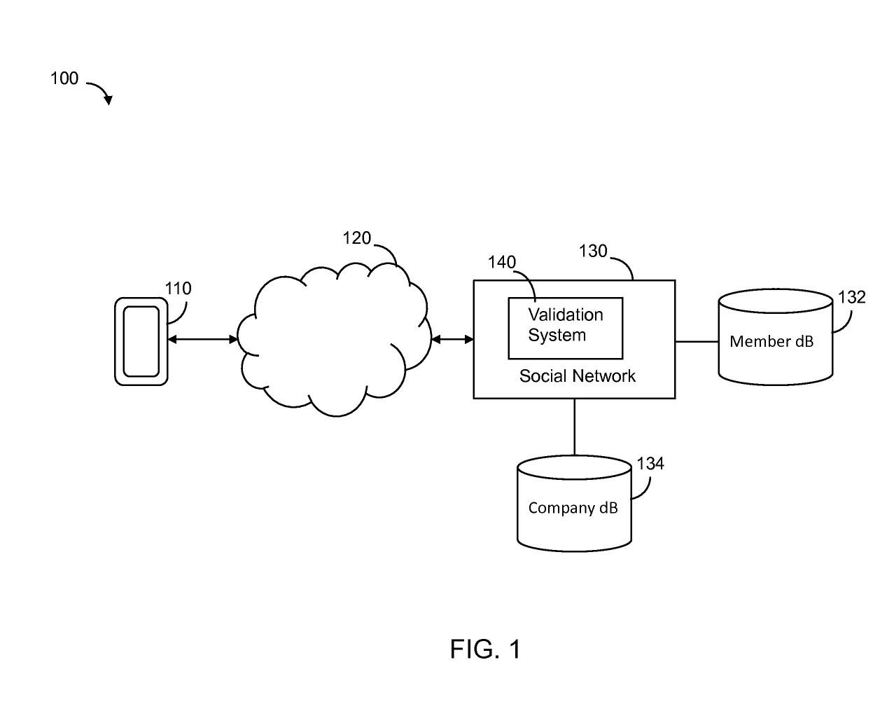

FIG. 1 is a block diagram illustrating an example of a network environment 100 including a server operating a system for validating a company using information from a social network, consistent with some embodiments. The network environment 100 includes a user device 110, such as a mobile device or computing device associated with a user, which accesses a social network service 130 over a network 120. The social network service 130 may be a professional social network or any social network that includes members, where a member is connected to, friends with, or otherwise affiliated with some of the other members of the network. The social network service 130 may include a validation system 140 that includes systems and performs methods for validating companies and individuals based on requests received from user devices 110, among other things.

The social network service 130 may contain, store, or have access to various types of information. In some examples, the social network service 130 may include or be associated with a member database 132 containing information associated with the members of the network. The member database 132 may include information assigned or attributed to each of the members of the social network service 130. For example, for a given member, the member database 132 may include some or all of the following information:

Biographical information, such as age, location, sex, marital status, and so on;

Education information, such as schools or universities attended by the member, degrees obtained by the member, certificates obtained by the member, classes taken by the member, grade information, and so on;

Professional information, such as companies that employed the member, skills attributed to the member, work history information, and so on;

Social graph information, such as other members connected to the member, information associated with connections, and so on;

Reference information, such as information about other members acting as references for the member, and so on; and

Other information that may be assigned and/or attributed to the member.

In some examples, the social network service 130 may include or be associated with a company database 134 containing information associated with companies that have a presence within the social network service 130 (e.g., post listings for available jobs, have company membership profiles), and so on. The company database 134 may include information assigned or attributed to companies within the social network service 130. For example, for a given company, the company database 132 may include some or all of the following information:

Member information, such as information identifying members of the social network that are associated with (e.g., currently or previously employed by) the company, and so on;

Presence information, such as job listings, advertisements, articles, posts, product or services reviews, likes or other feedback from members, and/or other information associated with the company's presence within the social network; and

Other information that may be assigned and/or attributed to the company.

In various example embodiments, one or more portions of the network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, any other type of network, or a combination of two or more such networks. The user device 110 may be any suitable computing device, such as a smart phone, a tablet, a laptop, gaming device, and/or any mobile device or computing device configured to display information, receive input, and/or receive selections from users of objects displayed by webpages, emails, and/or apps.

A social network, such as the social network service 130, is a useful place in which to obtain various types of information associated with companies, independent contractors, and/or other professionals. Often, a social network or other similar site, such as LinkedIn, Facebook, Google+, Twitter, and so on, stores various types of information or attributes associated with members, companies, and/or other entities of the site. For example, a friend-based social networking site may store interest information for a member (e.g., information about things a member “likes,” such as products, companies, organizations, and so on), whereas a business-based or professional social networking site may store accomplishment or experience information for a member (e.g., educational or work experience information) or for a company (e.g., members associated with the company, job listings provided by the company, product or service reviews, and so on). Additionally, the social network 130 may store a variety of information associated with a member's social graph, such as information identifying other members within the member's social graph.

Thus, in some examples, the social network service 130 receives search queries (e.g., queries with company names as keywords) from user device 110, performs searches for information within member database 132 and/or company database 134, and provides results of the searches to the user device 110.

In some examples, the provided results may include a determined validation score or metric that is based on the information obtained during the search. That is, the validation system 140 may obtain information about a company from the member database 132 and/or the company database 134, and generate, calculate, or otherwise determine a level of validation for the company.

### Validating Companies Using Social Network Information

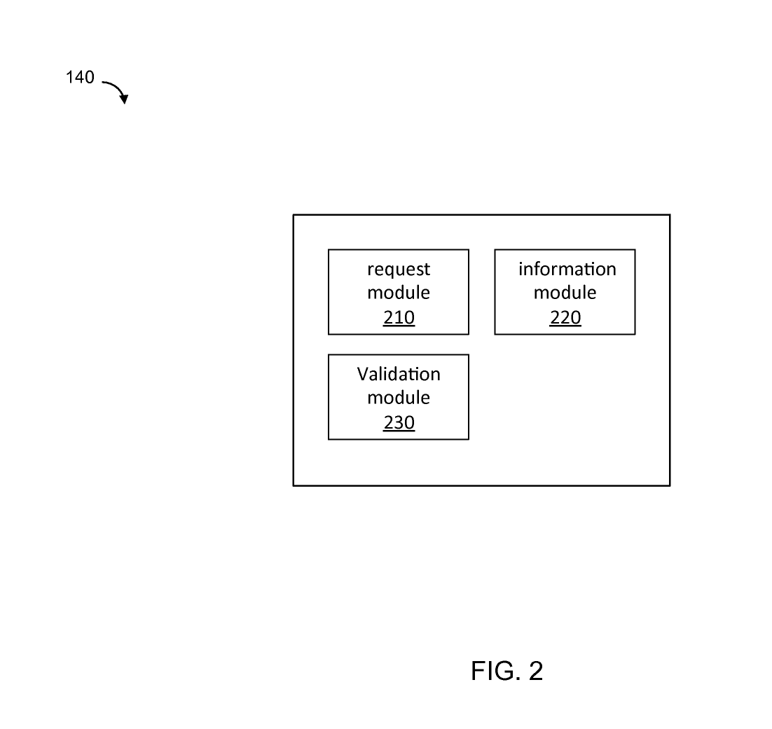

As described herein, in some examples, a validation system 140 utilizes information from a social network service in order to validate a company or other professional entity (e.g., company, organization, individual, independent contractor, product, service, and so on). FIG. 2 is a block diagram illustrating modules of a validation system 140, consistent with some embodiments.

As illustrated in FIG. 2, the validation system 140 includes a variety of functional modules, such as a search module 210, an information module 220, and a validation module 230. One skilled in the art will appreciate that the functional modules are implemented with a combination of software (e.g., executable instructions, or computer code) and hardware (e.g., at least a memory and processor). Accordingly, as used herein, in some embodiments a module is a processor-implemented module and represents a computing device having a processor that is at least temporarily configured and/or programmed by executable instructions stored in memory to perform one or more of the particular functions that are described herein.

In some examples, the request module 210 is configured and/or programmed to receive a request for information, such as a search query, associated with a company, such as a request receive from user device 110. The request module 210 may receive a variety of different types of requests, such as requests that identify a company, requests that identify an individual associated with a company, requests that identify an independent contractor, requests that identify a product or service, and so on.

In some examples, the information module 220 is configured and/or programmed to identify and/or obtain information associated with a requested company from a social network. For example, the information module 220 may identify and/or obtain information from the member database 132 and/or the company database 134.

In some examples, the validation module 230 is configured and/or programmed to validate a company or other professional entity based on information obtained from a social network. For example, the validation module 230 may provide information obtained via the information module 220 to the requesting system 115. The verification module 230 may provide the information in a number of ways, such as by directly communicating the information to the requesting system 115, transmitting a message to the user device 110 associated with the individual, performing an action via an application associated with the social network that is supported by the user device 110, and so on.

The validation module 230, in some examples, may calculate or determine a validation metric or score based on the obtained information associated with the individual. For example, the validation module 230 may validate a company based on the type of information obtained about the company, and provide an indication that represents such a determination. As another example, the validation module 230 may calculate a validity score or metric (e.g., a score between 1-100, a level of validity, and so on) that indicates a comparative or granular determination associated with the validity of the company.

In some examples, a request may be received from a non-member, or non-connection, of the social network, and the validation module 230 may provide a generalized version of the obtained information to the non-member. For example, the validation module 230 may generalize specific information about the company in order to satisfy privacy concerns before providing the information to the requesting non-member. However, when a request is received from a member or connection within the social network, the validation module 230 may provide the specific information to the requesting member or connection.

Of course, one or ordinary skill in the art will appreciate that the validation module 230 may utilize a variety of techniques, scenarios, and/or rules-based processes when performing a validation determination or calculation based on social network information associated with a company

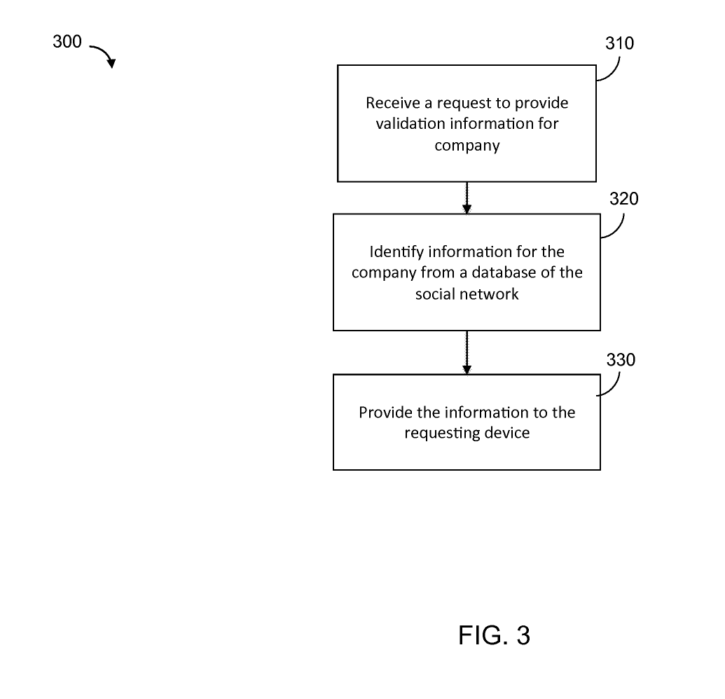

As described herein, the validation system 140 may perform a variety of processes or methods in order to validate a company using social network information. FIG. 3 is a flow diagram illustrating an example method 300 for validating a company using information from a social network, consistent with some embodiments.

In step 310, the social network 130 receives a request to provide information associated with a company. For example, the request module 210 of the validation system 140 may receive a request, such as a search query, from the user device 110 to provide information associated with a company.

As described herein, the request may be received in a variety of ways. In some examples, the social network 130 may provide a user interface object, such an a search input field, which facilitates receiving search queries from users of the social network 130. In some examples, the social network may provide a graphical button or other javascript object at a website that includes an advertisement or other information associated with a company, and receive requests to provide information about the company when the button is selected by users of the website).

In step 320, the social network identifies information associated with the company that is contained within the social network. For example, the information module 220 of the validation system 140 identifies and/or obtains information associated with a company from the member database 132 and/or the company database 134.

As described herein, the identified information may include a variety of different information, such as information associated with members affiliated with the company, information associated with the company's presence within the social network, and so on.

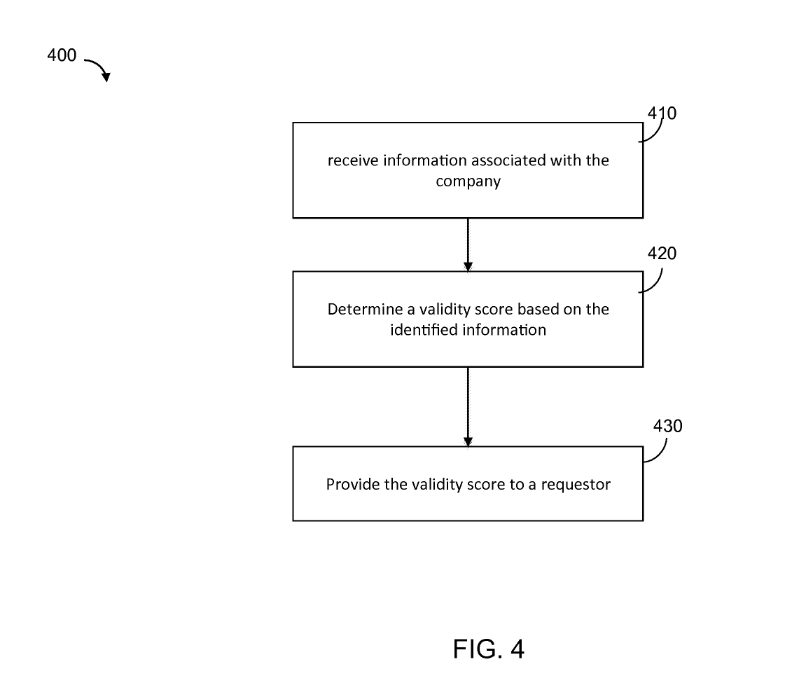

In step 330, the social network provides the information to the requesting device. For example, the validation module 230 of the validation system 140 returns a search query result to the user device 110 that includes the identified information. In some examples, as described herein, the validation module 230 may determine the validity of a company based on the identified information, and provide information to the requesting device that indicates the determined validity. FIG. 4 is a flow diagram illustrating an example method 400 for determining a validation score to a company, consistent with some embodiments.

In step 410, the validation module 230 receives information associated with a company, such as information located in member database 132 and/or company database 134. In step 420, the validation module 230 determines a validity score for the company based on the received information. One of ordinary skill in the art will appreciate that the validation module 230 may utilize a variety of techniques or rules-based processes when determined the validity of a company. Some example determinations include:

A company is valid when at least a threshold number of members of the social network are associated with the company;

A company is valid when the company posts at least a threshold number of job listings within the social network;

A company is not valid when there is no information within the social network about the company;

A company is not valid when a certain number of inactive members are associated with the company; and so on.

Returning to FIG. 4, in step 430, the validation module 230 provides the determined validity score, or an indication of the validity score, to a requestor. The validation module 230 may provide a numerical score (e.g., 75 out of 100) for the validity of a company, a level of validity (e.g., “valid” or “somewhat valid”), an absolute answer (e.g., “valid” or “not-valid”), and so on.

Thus, in some examples, a social network may provide information about a company and/or determine the validity of a company to a requestor based on information contained within the social network, among other things.

The following examples illustrate scenarios in which the validation system 140 described herein may be utilized:

Scenario 1—A member of a social network wants to find out more information about a relatively unknown Internet service provider named Heat Net that purports to provide high-speed communication services in his area. The member submits a query of “Heat Net” to the social network. The social network identifies no presence information about the company, and identifies a small number of members that are associated with the company. Based on the identified information, the social network does not validate the company, and provides an indication to the member indicating the determination not to validate the company.

Scenario 2—A homeowner wants to remodel her bathroom, and has a few referrals for contractors. The homeowner does not know any of the contractors, and submits search requests to an online professional network for each of the names of the contractors. The social network identifies information associated with each of the contractors, including reference information and information about the contractors' connections. The social network verifies the contractors based on the information, and provides the information to the homeowner. Using the provided information, the homeowner chooses one of the contractors to do the work.

### Conclusion

The various operations of example methods described herein may be performed, at least partially, by one or more processors that are temporarily configured (e.g., by software) or permanently configured to perform the relevant operations. Whether temporarily or permanently configured, such processors may constitute processor-implemented modules, engines, objects or devices that operate to perform one or more operations or functions. The modules, engines, objects and devices referred to herein may, in some example embodiments, comprise processor-implemented modules, engines, objects and/or devices.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

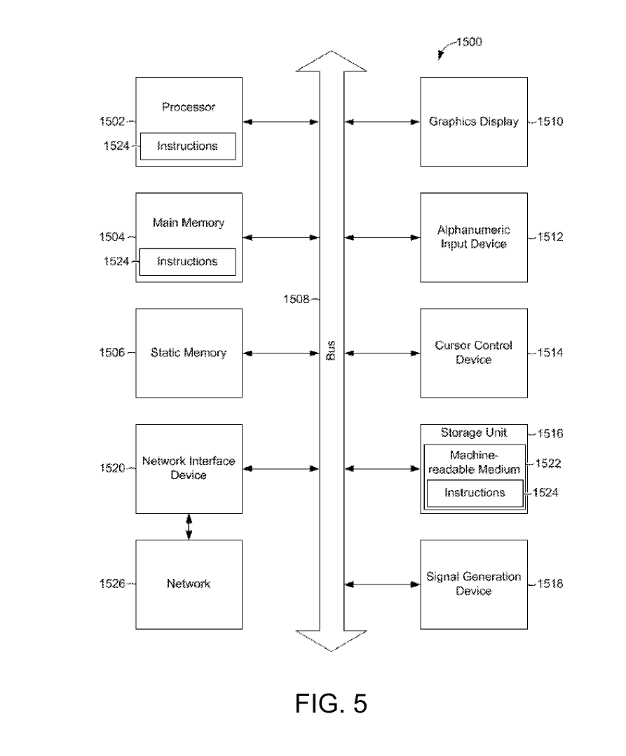

FIG. 5 is a block diagram of a machine in the form of a computer system or computing device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In some embodiments, the machine will be a desktop computer, or server computer, however, in alternative embodiments, the machine may be a tablet computer, a mobile phone, a personal digital assistant, a personal audio or video player, a global positioning device, a set-top box, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A method, comprising:
receiving, from a requesting device, a request to provide information associated with a company;
obtaining information associated with the company from a social network service;
using a processor to determine a validity score for the company based on the obtained information; and
providing the obtained information including the validity score to the requesting device.

2. (canceled)

3. The method of claim 1, wherein obtaining information associated with the company includes obtaining information associated with one or more members of the social network service that are affiliated with the company.

4. The method of claim 1, wherein obtaining information associated with the company includes obtaining information associated with job advertisements placed by the company within the social network service.

5. The method of claim 1, wherein obtaining information associated with the company includes obtaining information from a member database associated with the social network service.

6. The method of claim 1, wherein receiving a request from a requesting system includes receiving a request from a non-member of the social network service, and wherein providing the obtained information to the requesting system includes providing a generalized version of the obtained information to the non-member.

7. The method of claim 1, wherein receiving a request from a requesting system includes receiving a request from a member of the social network services, and wherein providing the obtained information to the requesting system includes providing information associated with the company to the member.

8. The method of claim 1, wherein receiving a request from a requesting system includes receiving a request from a member of the social network service that is not connected to the company via the social network service, and wherein providing the obtained information to the requesting system includes providing a generalized version of the obtained information to the member.

9. The method of claim 1, wherein receiving a request from a requesting system includes receiving a request from a member of the social network service that is connected to the company via the social network service, and wherein providing the obtained information to the requesting system includes providing information associated with the company to the member connected to the company.

10. A system, comprising:
a memory and at least one processor;
a request module configured to receive a request from a user device to provide validity information associated with a company;
an information module configured to obtain information associated with the company from a social network service;
a validity module, executable by the memory and the at least one processor, configured to determine a validity score for the company based on the obtained information;
the validity module further configured to provide the obtained information including the validity score to the user device.

11. (canceled)

12. The system of claim 10, wherein the information module is configured to obtain information associated with one or more members of the social network service that are affiliated with the company.

13. The system of claim 10, wherein the information module is configured to obtain information associated with job advertisements placed by the company within the social network service.

14. The system of claim 10, wherein the information module is configured to obtain information from a member database associated with the social network service.

15. A non-transitory computer-readable storage medium whose contents, when executed by a computing system, cause the computing system to perform a method, the method comprising:
receiving a request, from a requesting device, to provide information associated with a company;
obtaining information associated with the company from a social network service;
using a processor to determine a validity score for the company based on the obtained information; and
providing the obtained information including the validity score to the requesting device.

16. (canceled)

17. The non-transitory computer-readable storage medium of claim 15, wherein obtaining information associated with the company includes obtaining information associated with one or more members of the social network service that are affiliated with the company.

18. The non-transitory computer-readable storage medium of claim 15, wherein obtaining information associated with the company includes obtaining information associated with job advertisements placed by the company within the social network service.

19. The non-transitory computer-readable storage medium of claim 15, wherein obtaining information associated with the company includes obtaining information from a member database associated with the social network service.

20. The non-transitory computer-readable storage medium of claim 15, wherein receiving a request to provide information associated with a company includes receiving a request to provide an indication of a validity of the company; and wherein providing the obtained information to the requesting device includes providing information indicating the validity of the company.

21. The method of claim 1, wherein the using the processor to determine the validity score includes comparing the social network activity associated with the company to a threshold using the obtained information.

22. The system of claim 10, wherein the validity module is configured to determine the validity score by comparing the social network activity associated with the company to a threshold using the obtained information.

23. The non-transitory computer-readable storage medium of claim 15, wherein the using the processor to determine a validity score includes comparing the social network activity associated with the company to a threshold using the obtained information.
